(19) United States
(12) Patent Application Publication
(10) Pub. No.: US 2019/0019613 A1
(43) Pub. Date: Jan. 17, 2019

(54) HOLLOW TOROIDAL MAGNETIC POWER UNIT

(71) Applicant: PREMO, S.L., Campanillas (Màlaga) (ES)

(72) Inventors: Francisco Ezequiel NAVARRO PÉREZ, Barcelona (ES); Antonio ROJAS CUEVAS, Málaga (ES); Jorge RODRÍGUEZ, Málaga (ES); Marina ARCOS, Málaga (ES); Patrick FOUASSIER, Saint-Nazaire-Les-Eymes (FR); Raquel RODRÍGUEZ, Estepona (ES)

(21) Appl. No.: 16/030,144

(22) Filed: Jul. 9, 2018

(30) Foreign Application Priority Data
Jul. 11, 2017 (EP) 17382450.9

(51) Int. Cl. H01F 27/24; H01F 27/28; H01F 27/29; H01F 27/32; H01F 27/08

(52) U.S. Cl. CPC H01F 27/24; H01F 27/2823; H01F 27/08; H01F 27/32; H01F 27/29

(57) ABSTRACT

Hollow toroidal magnetic power unit including a hollow toroidal magnetic core (1) comprising a first partial toroidal core (10) having a first toroidal groove (11) and a second partial toroidal core (20) overlapped; and at least one toroidal coil (30) wound around the hollow toroidal magnetic core and at least one annular axial coil (40) wound around a coil-former (42) included within the first toroidal groove (11); the hollow toroidal magnetic core (1) including an annular gap (51) defined between the first and second partial toroidal cores, and a toroidal gap (52) defined by an interruption or an aperture in two opposed walls of at least the first partial toroidal core (10), preventing the magnetic saturation of the hollow toroidal magnetic core; wherein the size of said annular gap and toroidal gap are selected depending on the performances of the magnetic power unit.

### RELATED APPLICATION

This application claims priority to European application 17382450.9 filed Jul. 11, 2017, the contents of which are hereby incorporated by reference as if set forth in their entirety.

### TECHNICAL FIELD

The present invention refers to an integrated hollow toroidal magnetic power unit comprising a hollow toroidal magnetic core, including one or more independent toroidal coils wound around said hollow toroidal magnetic unit, which provides one or two independent inductors, and one or more annular axial coils wound around the central axis defined by said hollow toroidal magnetic core, providing a single or a double (for example common-mode) choke configuration. Other configurations with one or more toroidal coils and annular axial coils are still possible within the scope of this invention provided their windings being orthogonal.

The annular axial coil or coils are integrated, or fully enclosed within the hollow toroidal magnetic core, achieving a better performance and a compact construction. This configuration uses the soft magnetic core more efficiently as two independent components, that with conventional technology would use one independent core each, are here wound on just one magnetic device that behaves as two independent electric components.

This magnetic power unit is particularly adapted to be used for example as a power transformer or inductor in the electrical power field, suitable for operating a high power electrical device, especially usable in the field of hybrid and electrical vehicles (HEVs) that nowadays is growing quite fast. The new models of electrical vehicles require more and more power electronics inside, not only for the electrical motor supply with speed and torque control, but also for high-voltage (HV) battery chargers and stable in-car continuous low-voltage (LV) power supplies. In an embodiment, the proposed magnetic power has been designed for an interconnecting box between HV battery and HV component in an electrical vehicle.

The hollow toroidal magnetic power unit of this invention responds to a new volumetric efficiency concept on magnetic units.

It will be understood along this description that references to geometric position, such as parallel, perpendicular, tangent, etc. allow deviations up to ±5° from the theoretical position defined by this nomenclature. It will also be understood that any range of values given may not be optimal in extreme values and may require adaptations of the invention to these extreme values are applicable, such adaptations being within reach of a skilled person.

### BACKGROUND

U.S. Pat. No. 4,210,859 discloses an inductive device comprising a magnetic core and windings for producing two (see FIGS. 1 to 3) substantially orthogonal magnetic fields at all points within the core. A typical pot core is illustrated in FIG. 1. The core, which may be made of ferrite, magnetic iron steel or some other ferromagnetic material, comprises an outer cylindrical pot wall 30, a center post 32 and a pot cover 34. An annular space 40 is formed between the pot wall 30 and the center post 32. In this space is arranged a bobbin (not shown) which supports one or more coils of suitably dimensioned electrical wire. Since the post hole 36 and cover hole 38 may be considered to be the central hole of a toroid, it is possible to provide the pot core with an additional winding which passes through the central hole in one direction and back around the outside of the pot wall 30. Such a winding will be a type A winding because it is not completely enclosed by the pot core material.

EP patent application of the same applicant 16002354, discloses a compact magnetic power unit in which special solutions are provided to remove heat produced by the Foucault currents generated from the core of magnetic power unit particularly in the case of power transformers. FIG. 5 of this patent application shows an embodiment with a pot shaped magnetic core with an inner housing inside of which a coil is wound. Preferably two coils are wound around the magnetic core externally.

The present invention further develops the proposal of said embodiment, and includes embodiments with two annular axial coils, separated and electrically isolated, wound around the hollow toroidal magnetic core.

### BRIEF DESCRIPTION OF THE INVENTION

The present invention is directed to highly compact hollow toroidal magnetic power unit comprising, as known in the state of the art:
a hollow toroidal magnetic core concentric with a central axis, said hollow toroidal magnetic core defining an outer cylindrical surface and an inner cylindrical surface surrounding a tubular inner passage;
said magnetic core comprising a first partial toroidal core and a second partial toroidal core, being first and second partial toroidal cores overlapped and facing to each other; and
said first partial toroidal core having a first toroidal groove, concentric with the central axis, accessible through the surface of the first partial toroidal core facing the second partial toroidal core;
at least one toroidal coil made of an isolated electro-conductive wire wound around the hollow toroidal magnetic core;
at least one annular axial coil made of an isolated electro-conductive wire wound around a coil-former included within the first toroidal groove.

As will be understood a magnetic core is an element made of a material with a high magnetic permeability with the ability to confine and guide magnetic fields.

According to the invention the hollow toroidal magnetic core is formed by at least two different partial magnetic cores, corresponding to a first and second partial toroidal cores, assembled together by an attachment as a composed core in a layered configuration.

It is known in the state of the art, by the cited document U.S. Pat. No. 4,210,859, that first partial toroidal core having a toroidal groove defined therein, being said first partial toroidal core a body of revolution obtained from a U-shaped section. According to this document it is known to wound the annular axial coil around a coil-former included within the first toroidal groove. This feature allows an easy wounding operation of the annular axial coil around the coil-former and a posterior insertion of said wounded coil-former in the first toroidal groove.

The toroidal coil will be a coil wounded passing each turn through the inner passage, each turn crossing the inner cylindrical surface and the outer cylindrical surface.

The annular axial coil will be a coil wounded around the central axis of the hollow toroidal magnetic core.

The present invention proposes, as innovative features, the following features not known from the state of the art:
the hollow toroidal magnetic core includes an annular gap defined between the first and second partial toroidal cores in a plane perpendicular to the central axis, and a toroidal gap defined by an interruption of the annular continuity of at least the first partial toroidal core or by an access opening provided in the outer cylindrical surface of at least the first partial toroidal core, said toroidal gap being defined in a plane parallel and coincident with the central axis, preventing the magnetic saturation of the hollow toroidal magnetic core;
the hollow toroidal magnetic power unit is attached to an electric insulating support base, said support base including multiple pairs of metallic connection terminals, each pair of metallic connection terminals being connected to respective ends of one wire constitutive of one toroidal coil or of one annular axial coil;
the wire connecting each annular axial coil with the respective pair of metallic connection terminals being introduced within the first toroidal groove through an access opening provided in outer cylindrical surface of the hollow toroidal magnetic core without electrical contact with said hollow toroidal magnetic core; and wherein
the size of said annular gap and toroidal gap are selected depending on the performances of the magnetic power unit.

In a preferred embodiment, the hollow toroidal magnetic core is made of an electric conductive material, and the at least one toroidal coil and the at least one annular axial coil are electrically isolated, with an electric insulant element, regarding the hollow toroidal magnetic core;

Being the at least one toroidal and annular axial coils electrically isolated from the hollow toroidal magnetic core, the hollow toroidal magnetic core can be made not only of a magnetic conductive material, but also of a magnetic electroconductive material.

The magnetic core here disclosed can be made, for example, of a material selected among ferrite, ferromagnetic material, or a PBM (polymer-bonded soft magnetic material) injectable material and as indicated with electromagnetic properties. Besides, thanks to the design of the invention (several orthogonal coils around a single magnetic core) an important saving of the core material is also obtained.

Typically, the best magnetic conductive materials, having higher permeability with competitive prices, are also electro conductive materials (typically Mn Zn ferrites and Fe Si alloys). This power unit is designed to be connected to a high-power circuit; therefore, an elevated magnetic saturation limit and permeability of the material constitutive of the hollow toroidal magnetic core determines the size of the power unit and the power limit managed by said power unit. Therefore, the isolation of the toroidal and annular axial coils allows the selection of the best material for the hollow toroidal magnetic core, achieving a smaller power unit with higher performance. Preferably the hollow toroidal magnetic core is made of a Manganese Zinc alloy which has an elevated magnetic permeability.

The cited annular and toroidal gaps define an exit scape for the magnetic fields contained and guided by the hollow toroidal magnetic core.

The annular gap is defined in a plane perpendicular to the central axis, and prevents the magnetic saturation produced by the magnetic fields induced by the current conducted through the at least one annular axial coil.

The toroidal gap is defined in a plane parallel and coincident with the central axis, and prevents the magnetic saturation produced by the magnetic fields induced by the current conducted through the at least one toroidal coil.

Therefore, said annular and toroidal gaps prevent the magnetic saturation of the hollow toroidal magnetic core permitting an increase of the power conducted through the toroidal coil and the annular axial coil without increasing the size of the hollow toroidal magnetic core, or permits a reduction of the hollow toroidal magnetic core size, achieving a more compact power unit. The size of said annular and toroidal gaps can be adapted, optimizing each hollow toroidal power unit to the circuit to which it is connected.

The proposed power unit can be assembled onto electric insulating support base, and said support base include multiple pairs of metallic connection terminals.

Each toroidal coil and each annular axial coil is made of a single wire wounded multiple turns around the magnetic core. Each wire has two opposed ends which are electrically connected to said pair of metallic connection terminals. This feature permits an easy and safe connection of the hollow toroidal power unit proposed to a circuit.

The respective ends of the wires constitutive of said at least one annular axial coil are introduced within the first toroidal groove through an access opening provided in the outer cylindrical surface of the hollow toroidal magnetic core. Said access opening is preferably coincident with the toroidal gap and connected to the toroidal gap, permitting an easy insertion of the coil-former, carrying the at least one annular axial coil, within the hollow toroidal magnetic core in the central axis direction.

The wires cannot be in electrical contact neither with the hollow toroidal magnetic core nor with the access openings.

When the air gap cited above is defined between the first and second partial toroidal cores, said first and second partial toroidal cores are, according to a preferred embodiment, spaced apart by spacers placed there between, or by spacers defined by protrusions protruding from the surfaces of the first and second partial toroidal cores facing each other.

Said spacers can be, for example, protrusions of the first and/or second partial toroidal cores, or alternatively can be provided by the coil-former, by the electric isolated support base or by another structure non-included within the hollow toroidal magnetic core.

According to an embodiment of the present invention both first and second partial toroidal cores have toroidal grooves. The coil-former of the at least one annular axial coil is therefore partially inserted within the first toroidal groove, provided in the first partial toroidal core, and simultaneously partially inserted in the second toroidal groove provided in the second partial toroidal core.

This feature determine that the cited annular gap is placed in an intermediate position of the outer cylindrical surface of the hollow toroidal magnetic core, said gab facing the annular axial coil, having first and second partial toroidal cores a similar or identical size, offering similar or identical magnetic saturation limit and therefore optimizing the power conducted through the hollow toroidal power unit.

Preferably said first and second partial toroidal cores are symmetric. In this case the annular gap is exactly in a central position of the outer cylindrical surface of the hollow toroidal magnetic core, being both first and second partial toroidal cores equal in size, providing equal magnetic saturation level.

The electric insulant element cited above can be, for example, a hollow toroidal shell surrounding the hollow toroidal magnetic core. Said electric insulant element can be formed by two toroidal shells coupled together surrounding the hollow toroidal magnetic core. Alternatively, the electric insulant element can be an electric insulant material over-molded around the hollow toroidal magnetic core.

In an additional alternative embodiment, said at least one toroidal coil is made of a wire covered with said electric insulant element being a flexible material, so that after wounding said insulated wire around the hollow toroidal magnetic core the insulant material isolates the wire constitutive of the toroidal coil from the hollow toroidal magnetic core.

The isolation of the at least one annular axial coil can be achieved using a coil-former made of an electrical insulating material, heat conductive polymer, for example.

Another embodiment of the present invention is to provide at least two independent toroidal coils wounded around the same hollow toroidal magnetic core. This provides the present power unit of capabilities only achievable using two different power units with respective different magnetic cores.

This embodiment can be achieved using at least two different wires, each isolated with said electric insulant element. Each single turn of one independent toroidal coil, wounded around the hollow toroidal magnetic core, shall be placed between consecutive turns of the other independent toroidal coil wounded around the hollow toroidal magnetic core. This solution provides two or more toroidal coils wounded around the hollow toroidal magnetic core.

According to an alternative solution of this embodiment said at least one toroidal coil comprises two independent toroidal coils, being each independent toroidal coil wounded around a different circular sector of the hollow toroidal magnetic core, being said different circular sectors defined by a magnetic wall parallel and coincident with the central axis placed within the tubular inner passage. Said magnetic wall separates the magnetic fields of the two independent toroidal coils wounded around different circular sectors of the hollow toroidal magnetic core, preventing interferences which could reduce the efficiency of the power unit.

Alternatively, is proposed that the power unit includes at least two independent annular axial coils having equal diameter and being spaced apart in the direction of the central axis. This feature permits the integration of two different choke configurations into the same hollow toroidal power unit.

The magnetic power unit, including the toroidal coil, is preferably covered with an electric insulant material over-molded leaving the pairs of metallic connection terminals uncovered, protecting the hollow toroidal power unit and preventing manipulation or accidents.

Preferably a thermally conductive element is inserted within the inner passage of the hollow toroidal magnetic core and in thermal contact with the hollow toroidal magnetic power unit said thermally conductive element being integrated in a cooling structure including a heatsink. Said thermally conductive element permits the evacuation of the heat produced within the power unit.

In a preferred embodiment, the thermally conductive element is a hollow pipe filled with a fluid with a low boiling point.

The method of production of the hollow toroidal magnetic power unit is also proposed as part of a second aspect of the present invention, said method including wounding at least one annular axial coil around the coil-former, then the insertion of said coil-former, carrying the at least one annular axial coil, within the first toroidal groove of the first partial toroidal core. Then the second partial toroidal core is placed overlapped and facing an annular face of the first partial toroidal core leaving an annular gap there between. The width of said annular gap can be defined by a spacer placed there between, for example a protrusion of the coil-former, and therefore can be adapted to each single use of the power unit produced.

When the second partial toroidal core includes a second groove the coil-former is also inserted therein.

Connection wires of the at least one annular axial coils exit from the hollow toroidal magnetic core through access openings provided in the outer cylindrical surface of the hollow toroidal magnetic core.

Then, according to a first embodiment of the method, the hollow toroidal magnetic core is encapsulated within an electric insulant element, for example by over-molding a plastic cover around it, or assembling two toroidal shells around it. At least one toroidal coil is then wound around the insulated hollow toroidal magnetic core.

Alternatively, the hollow toroidal magnetic core can be not insulated with the electric insulant element if the conductive wire constitutive of the toroidal core is a wire insulated with the electric insulant element, for example a flexible plastic covering said conductive wire.

Then the power unit is attached to a support base and the wires constitutive of the annular and toroidal coils are connected to metallic connection terminals integrated on said support base.

It will also be understood that any range of values given may not be optimal in extreme values and may require adaptations of the invention to these extreme values are applicable, such adaptations being within reach of a skilled person.

Other features of the invention appear from the following detailed description of an embodiment.

### BRIEF DESCRIPTION OF THE DRAWING

The foregoing and other advantages and features will be more fully understood from the following detailed description of an embodiment with reference to the accompanying drawings, to be taken in an illustrative and not limitative, in which:

FIG. 1 shows a perspective exploded view of an embodiment of proposed hollow power unit, which is provided with two symmetric partial toroidal cores, housing at least one annular axial coil, spaced apart by a spacer producing an annular gap, said hollow toroidal magnetic core being covered by an electric insulant element having the shape of two symmetric toroidal shells, and being two toroidal coils wounded over said electric insulant element surrounding the hollow toroidal magnetic core;

FIG. 2 shows a transversal section of the hollow toroidal power unit shown on FIG. 1. While the embodiment of the FIG. 1 includes a support base and a thermally conductive element to dissipate the heat, said elements have not being shown in FIG. 2 to increase the clarity of the Figure;

FIG. 3 shows a perspective view of an alternative embodiment of the present invention, this embodiment having two toroidal coils, both made of an isolated conductive wire wounded around the hollow toroidal magnetic core, which is supported on a support base provided with metallic connection terminals;

FIG. 4 shows a transversal section of the hollow toroidal power unit shown on FIG. 3, being the support base and the thermally conductive element not shown to increase the clarity of this Figure;

FIG. 5 shows a transversal section according to an alternative embodiment, wherein the first partial toroidal core includes the first toroidal groove, and wherein the second partial toroidal core is an annular lid covering said toroidal groove, being the annular gap not centered in the outer cylindrical surface of the hollow toroidal magnetic core, being the support base and the thermally conductive element not shown in order to increase the clarity of this Figure;

FIG. 6 shows a transversal section according to an alternative embodiment, wherein two different annular axial coils are wounded around the central axis, and electrically insulated among them (providing for example, a common-mode choke configuration) and wherein the electric insulant element is made of plastic over-molded around the hollow toroidal magnetic core, being the toroidal coil wounded around said electric insulant element. The support base and the thermally conductive element have not been included to increase the clarity of this figure.

FIG. 7 shows a perspective view of the hollow toroidal power unit according to an additional embodiment wherein two different and opposed sectors of the hollow toroidal magnetic core are wounded by two different toroidal coils made of insulated conductive wire, having the support base a protruding wall inserted within the inner passage, separating the two different toroidal coils;

FIG. 8 shows an exploded view of the hollow toroidal power unit shown on FIG. 7.

### DETAILED DESCRIPTION

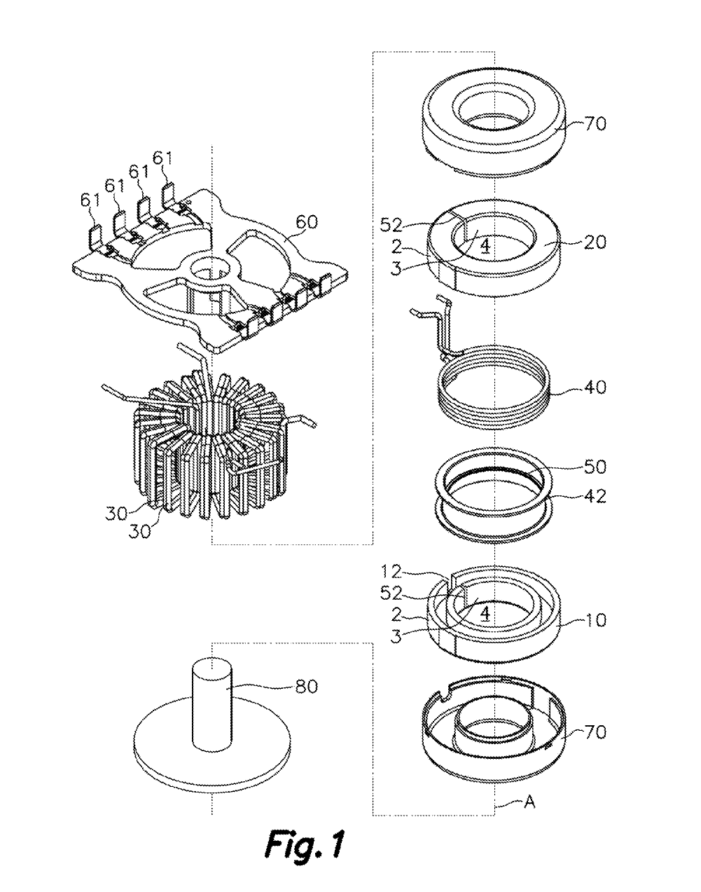

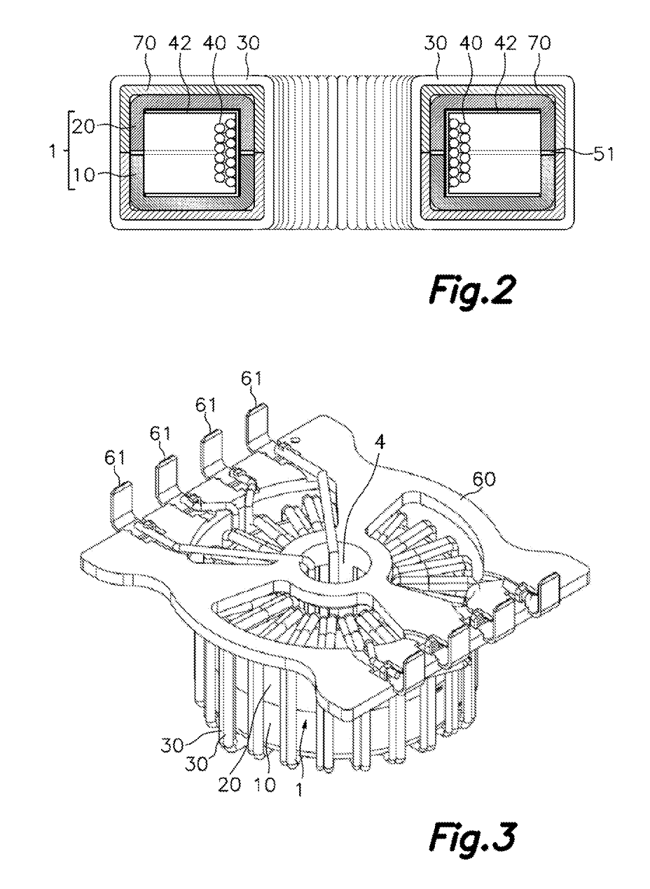

FIGS. 1 to 8 show exemplary embodiments with non-limiting illustrative character of the hollow toroidal power unit proposed in the present invention.

According to an embodiment of the present invention the hollow toroidal power unit includes a hollow toroidal magnetic core 1 made of a magnetic and electric conductive material, preferably a zinc alloy material which has a high magnetic saturation level.

The hollow toroidal magnetic core 1 is a body of revolution obtained from a squared section revolved around a central axis A. Said hollow toroidal magnetic core 1 defines an inner cylindrical surface 3, surrounding an inner passage 4, and an outer cylindrical surface 2, both concentric with the central axis A.

Said hollow toroidal magnetic core 1 is made of a first partial toroidal core 10 and a symmetric second toroidal partial core 20, having both toroidal partial cores 10 and 20 corresponding annular faces facing each other.

The first partial toroidal core 10 includes a first toroidal groove concentric with the central axis A, being said toroidal groove accessible through said annular face of the first partial toroidal core 10.

The second partial toroidal core 20 is, according to the present embodiment, symmetric and includes a second toroidal groove symmetric to the first toroidal groove. When first and second partial toroidal cores 10 and 20 are facing each other both first and second partial toroidal cores define a hollow toroidal magnetic core 1. This feature can be shown in FIGS. 1, 2, 3, 4, 6, 7 and 8.

A coil-former 42 made of plastic is inserted within said hollow toroidal magnetic core 1, said coil-former 42 receiving an annular axial coil 40 wounded around. Being the coil-former 42 inserted within the toroidal groove said annular axial coil 40 is concentric to the central axis A.

Said coil-former 42 is defined, according to the embodiments shown on FIGS. 1, 2, 4 and 5, by a cylindrical wall concentric to the central axis A and by two annular flanges, defining an annular channel where the annular axial coil 40 can be easily wounded when the coil-former 42 is extracted from the hollow toroidal magnetic core 1. This feature permits an easy wounding operation of the annular axial coil 40 around the coil-former 42, and an easy assembly of said annular axial coil 40 within the hollow toroidal magnetic core 1, ensuring the correct electrical insulation of the annular axial coil 40 from the hollow toroidal magnetic core

According to an alternative embodiment of this feature, shown on FIGS. 6, 7 and 8, the coil-former 42 include two coil-formers or one coil-former 42 having an intermediate flange 50 defining two wounding annular channels. This permits wounding two independent annular axial coils 40 of the same diameter, each obtained from a different conductive wire. In this way, a common-mode choke configuration, storing electrical current in the form of magnetic field (to act as an electrical current filter, absorbing current ripple), in addition to a transformer by the toroidal coils 30, can be obtained or in an alternative the two coils of a transformer can be enclosed within the hollow toroidal magnetic core.

The inclusion of more than two annular axial coils 40 within the hollow toroidal magnetic core 1 is also contemplated.

Both first and second partial toroidal cores 10 and 20 include one toroidal gap 52 defined in a plane parallel and coincident with the central axis A, said toroidal gap 52 being an interruption of the annular continuity of the material constitutive of the first partial toroidal core 10 and of the second partial toroidal core 20. Preferably said gap of the first and the second toroidal partial cores are coincident.

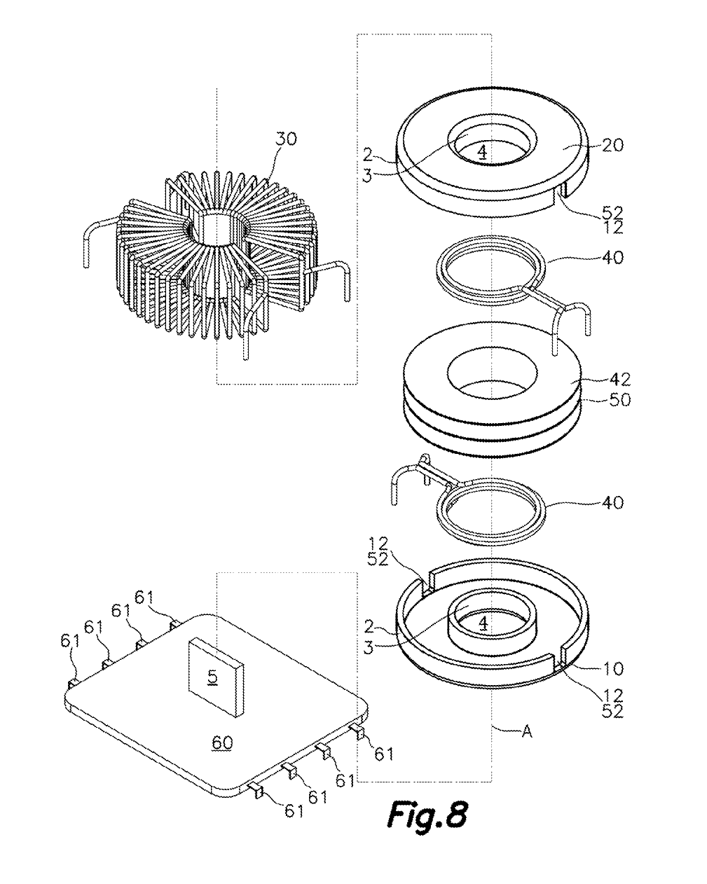

Said toroidal gap 52 offers an exit to the magnetic fields created and guided by the toroidal coil 30 on said hollow toroidal magnetic core 1 preventing the magnetic saturation of the hollow toroidal magnetic core 1. Said toroidal gap 52 can interrupt completely the magnetic material continuity of the hollow toroidal magnetic core 1, has shown on FIG. 1, or can be a partial interruption, has shown on FIG. 8 wherein the toroidal gap 52 is also an access opening 12 for the connection of the annular axial coil 40 with the correspondent metallic connection terminals 61, passing the wires through said access opening 12.

The access opening 12 are preferably provided in the outer cylindrical surface 2 of the hollow toroidal magnetic core 1.

In addition, each hollow toroidal magnetic core 10, 20 also include an annular gap 51 defined in a plane perpendicular to the central axis A, being placed said annular gap 51 between the first and second partial toroidal cores 10 and 20.

According to the present embodiment of the invention, the hollow toroidal magnetic core 1, containing the annular axial coil 40, is encapsulated within an electric insulant element 70 made of a hollow toroidal shell of electric insulating material. Said hollow toroidal shell is made of two toroidal shells coupled together around the hollow toroidal magnetic core 1.

Alternatively said electric insulant element 70 is an over-moulded electric insulating material, for example plastic.

A toroidal coil 30 of conductive wire is wounded around said hollow toroidal magnetic core 1 covered with the electric insulating element 70.

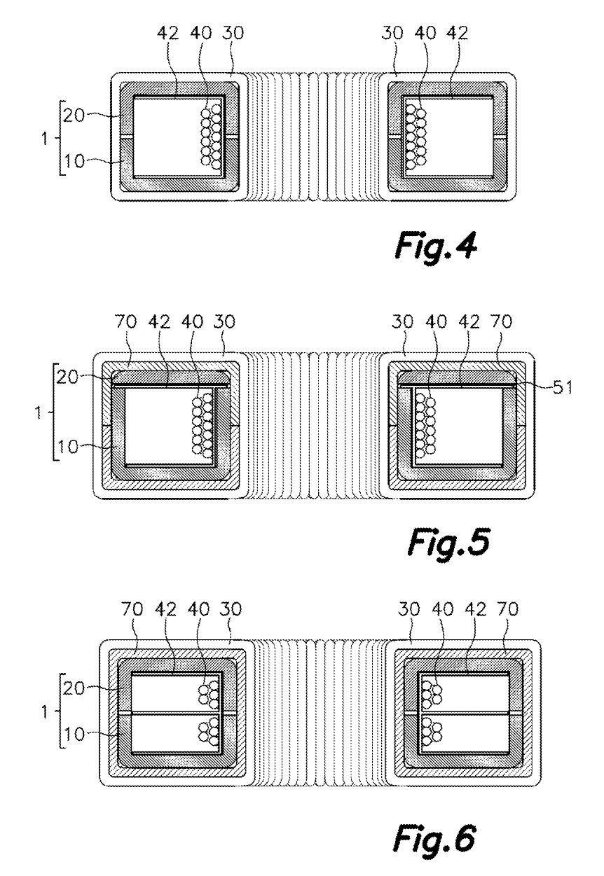

In an alternative embodiment, the hollow toroidal magnetic core 1 is not encapsulated with electric insulant element 70, and the toroidal coil 30 is wounded directly around the hollow toroidal magnetic core 1, but in this embodiment the conductive wire constitutive of the toroidal coil 30 shall be an electric insulated conductive wire, covered with the electric insulant element 70, as shown on FIGS. 4, 7 and 8.

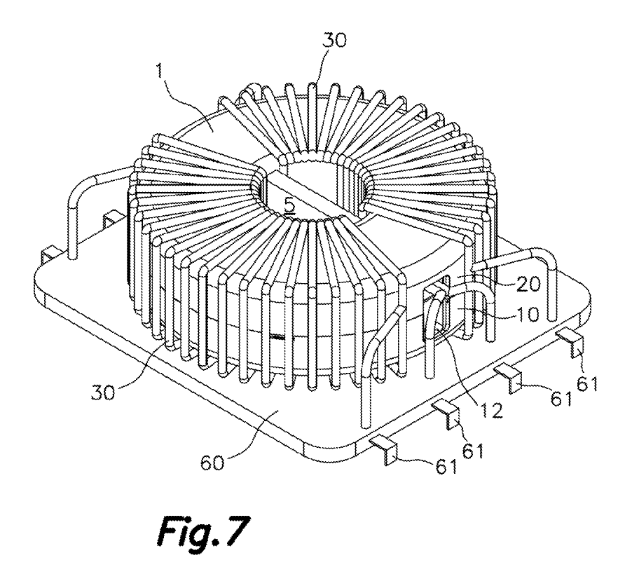

According to an embodiment of the present invention the hollow toroidal magnetic core 1 comprises two toroidal coils 30 (see FIGS. 1, 3, 7 and 8). Said two toroidal coils 30 can be wounded in different annular sectors of the hollow toroidal magnetic core (FIGS. 7 and 8), said annular sectors being preferably defined by a partition wall 5 inserted within the inner passage 4 of the hollow toroidal magnetic core, and coincident with the central axis A.

Alternatively the two toroidal coils 30 can be wounded in parallel (FIGS. 1 and 3), being each turn of one toroidal coil 30 wound between two adjacent turns of the other toroidal coil 30. The two toroidal coils 30 can provide a transformer.

The cited hollow toroidal power unit described above is attached to an insulant support base 60, which is provided with metallic connection terminals 61. Each conductive wire constitutive of a toroidal coil 30 or an annular axial coil 40 has respective two opposed ends each connected to one metallic connection terminal 61 of the support base 60. Said metallic connection terminals 61 permit an easy, reliable and safe electric connection between the hollow toroidal power unit and an electric circuit.

The invention also proposes the insertion of a thermally conductive element 80 within the inner passage 4 of the hollow toroidal magnetic core 1, being said thermally conductive element 80 in thermal contact with the toroidal magnetic power unit. Said thermally conductive element 80 is integrated in a cooling structure including a heatsink, for example a sink plate, in such a way that the heat produced within the hollow toroidal power unit is conducted from the inner passage 4 to the sink plate through the thermally conductive element 80, producing a cooling effect of the hollow toroidal power unit.

Preferably the hollow toroidal power unit is covered by an over-moulded cover, only leaving uncovered the metallic connection terminals 61 and, if there is a thermal conductive element 80 also leaving uncovered the correspondent sink plate. Said over-moulded cover can also be introduced within the interspace between the inner cylindrical surface 3 of the hollow toroidal magnetic core 1 and the thermal conductive element 80, assuring the thermal transmission there between.

It will be understood that various parts of one embodiment of the invention can be freely combined with parts described in other embodiments, even being said combination not explicitly described, provided there is no harm in such combination.

1. A hollow toroidal magnetic power unit including:
a hollow toroidal magnetic core (1) concentric with a central axis (A), said hollow toroidal magnetic core (1) defining an outer cylindrical surface (2) and an inner cylindrical surface (3) surrounding a tubular inner passage (4);
said hollow toroidal magnetic core (1) comprising a first partial toroidal core (10) and a second partial toroidal core (20), being said first and second partial toroidal cores (10, 20) overlapped and facing to each other; and
said first partial toroidal core (10) having a first toroidal groove (11), concentric with the central axis (A), accessible through a surface of the first partial toroidal core (10) facing the second partial toroidal core (20);
at least one toroidal coil (30) made of an isolated electro-conductive wire wound around the hollow toroidal magnetic core;
at least one annular axial coil (40) made of an isolated electro-conductive wire wound around a coil-former (42) included within the first toroidal groove (11);
wherein the hollow toroidal magnetic core (1) includes an annular gap (51) defined between the first and second partial toroidal cores (10, 20) in a plane perpendicular to the central axis (A), and a toroidal gap (52) defined by an interruption of the annular continuity of at least the first partial toroidal core (10) or by an access opening provided in the outer cylindrical surface (2) of at least the first partial toroidal core (10), said toroidal gap (52) being defined in a plane parallel and coincident with the central axis (A), preventing the magnetic saturation of the hollow toroidal magnetic core (1);
wherein the hollow toroidal magnetic power unit is assembled onto an electric insulating support base (60), said support base (60) including multiple pairs of metallic connection terminals (61), each pair of metallic connection terminals (61) being connected to respective ends of said isolated electro-conductive wire constitutive of one toroidal coil (30) or of one annular axial coil (40); and
wherein the isolated electro-conductive wire connecting each annular axial coil (40) with the respective pair of metallic connection terminals (61) being introduced within the first toroidal groove (11) through an access opening (12) provided in the outer cylindrical surface (2) of the hollow toroidal magnetic core (1) without electric contact with said hollow toroidal magnetic core (1),
wherein the size of said annular gap (51) and toroidal gap (52) are selected depending on the performances of the magnetic power unit.

2. Hollow toroidal magnetic power unit according to claim 1 wherein the hollow toroidal magnetic core (1) is made of a magnetic electro-conductive material and the at least one toroidal coil (30) and the at least one annular axial coil (40) are electrically isolated, with an electric insulant element (70) regarding the hollow toroidal magnetic core (1).

3. Hollow toroidal magnetic power unit according to claim 1 wherein the annular gap (51) is defined between the first and second partial toroidal cores (10, 20), being said first and second partial toroidal cores (10, 20) spaced apart by spacers (50) placed there between, or by spacers (50) defined by protrusions protruding from the surfaces of the first and second partial toroidal cores (10, 20) facing each other, or by protrusions protruding from an inner wall of the coil-former (42).

4. Hollow toroidal magnetic power unit according to claim 3 wherein the second partial toroidal core (20) has a second toroidal groove (21), concentric with the central axis (A), accessible through the surface of the second partial toroidal core (20) facing the first partial toroidal core (10), and wherein the coil-former (42) is included also within the second toroidal groove (21).

5. Hollow toroidal magnetic power unit according to claim 2, wherein the electric insulant element (70) provided between the at least one toroidal coil (30) and the hollow toroidal magnetic core (1) is:
a hollow toroidal shell surrounding the hollow toroidal magnetic core (1); or
a hollow toroidal shell surrounding the hollow toroidal magnetic core (1) formed by two toroidal shells coupled together surrounding the hollow toroidal magnetic core (1).

6. Hollow toroidal magnetic power unit according to claim 2, wherein the electric insulant element (70) provided between the at least one toroidal coil (30) and the hollow toroidal magnetic core (1) is an electrical insulant material over-molded around the hollow toroidal magnetic core (1).

7. Hollow toroidal magnetic power unit according to claim 2, wherein the electric insulant element (70) provided between the at least one toroidal coil (30) and the hollow toroidal magnetic core (1) is the conductive wire covered with said electric insulant element (70).

8. Hollow toroidal magnetic power unit according to claim 2 wherein the electric insulant element (70) placed between the at least one annular axial coil (40) and the hollow toroidal magnetic core (1) is said coil-former (42) being made of an electrical insulating material.

9. Hollow toroidal magnetic power unit according to claim 1 wherein said at least one toroidal coil (30) is at least two independent toroidal coils (30) being each single turn of one independent toroidal coil (30) placed between consecutive turns of other independent toroidal coil (1).

10. Hollow toroidal magnetic power unit according to claim 1 wherein said at least one toroidal coil (30) is two independent toroidal coils (30), being each independent toroidal coil (30) wounded around a different circular sector of the hollow toroidal magnetic core (1).

11. Hollow toroidal magnetic power unit according to claim 1 wherein said at least one annular axial coil (40) are at least two independent annular axial coils (40) having equal diameter and being spaced apart in the direction of the central axis (A), end electrically isolated.

12. Hollow toroidal magnetic power unit according to claim 1 wherein the magnetic power unit, including the hollow toroidal coil (30), is covered with an electric insulant material over-molded leaving the pairs of metallic connection terminals (61) uncovered.

13. Hollow toroidal magnetic power unit according to claim 1 wherein the hollow toroidal magnetic core (1) is made of a Manganese Zinc alloy.

14. Hollow toroidal magnetic power unit according to claim 1 wherein a thermally conductive element (80) is inserted within the inner passage (4) of the hollow toroidal magnetic core (1) and in thermal contact with the hollow toroidal magnetic power unit, said thermally conductive element (80) being integrated in a cooling structure including a heatsink.

15. Hollow toroidal magnetic power unit according to claim 2 wherein said magnetic electro-conductive material is selected among Mn Zn ferrites and Fe Si alloys.
